(19) United States
(12) Patent Application Publication
(10) Pub. No.: US 2022/0374741 A1
(43) Pub. Date: Nov. 24, 2022

(54) INFERENCE APPARATUS, INFERENCE METHOD, AND COMPUTER READABLE RECORDING MEDIUM

(71) Applicant: NEC Corporation, Minato-ku, Tokyo (JP)

(72) Inventor: Daichi KIMURA, Tokyo (JP)

(73) Assignee: NEC Corporation, Minato-ku, Tokyo (JP)

(21) Appl. No.: 17/771,883

(22) PCT Filed: Nov. 8, 2019
(86) PCT No.: PCT/JP2019/043972

§ 371 Date: Apr. 26, 2022

(51) Int. Cl. G06N 5/04; G06N 5/02

(52) U.S. Cl. CPC G06N 5/04; G06N 5/022; G06N 5/025

(57) ABSTRACT

An inference apparatus 10 includes: a hypothesis candidate generation unit 11 configured to perform inference by applying inference knowledge that includes information indicating a temporal sequence to observation in which facts that have been observed are expressed using logical expressions, and thereby generate a hypothesis candidate from which the observation can be derived; and a contradiction examination unit 12 configured to determine, on the basis of the information indicating a temporal sequence, whether or not the generated hypothesis candidate includes a temporal contradiction.

### TECHNICAL FIELD

The present invention relates to an inference apparatus and an inference method for deriving hypotheses by applying inference knowledge to events that have been observed, and further relates to a computer readable recording medium for realizing the inference apparatus and inference method.

### BACKGROUND ART

In the field of cyber security for example, when events are observed in a computer system, it is necessary to determine whether or not the events that have been observed have been caused by a cyberattack. Abductive inference is the most promising among techniques for carrying out such a determination.

In abductive inference, a reasonable hypothesis is derived from events that have been observed (observed events) and inference knowledge (rules) provided in the form of logical formulae. Accordingly, in the above-described example, it can be easily determined whether or not there has been a cyberattack by deriving a hypothesis by applying the observed events to rules prepared in advance for the computer system.

Furthermore, there are cases in which a plurality of hypotheses are derived instead of a single hypothesis, and weighted abductive inference (for example, see Non-Patent Document 1) is a technique for specifying the best hypothesis in such cases. In weighted abductive inference, a weight is assigned to each rule, and furthermore, a cost is assigned to each observed event. Then, hypothesis candidates are generated by backward reasoning being performed on the rules provided with their weights and the observed events provided with their costs, and in addition, the costs of the individual hypothesis candidates are calculated by unification. Furthermore, among the generated hypothesis candidates, a hypothesis candidate with lower cost is regarded as a better hypothesis.

Here, abductive inference will be described based on a specific example. For example, suppose that the rules shown below exist. Furthermore, in the rules shown below, the numerical value on the left side indicates a weight.

stepA(m):1.6⇒stepX(m)

stepX(m):1.6⇒stepB(m)

stepB(m):1.6⇒stepC(m)

stepC(m):1.6⇒goal(m)

stepB(m):1.2⇒stepY(m)

stepY(m):1.2⇒stepA(m)

stepA(m):1.2⇒stepC(m)

Furthermore, suppose that the observed events shown below (hereinafter “observations”) have been provided. The numerical values in the observations shown below are costs.

stepA(M):100∧stepB(M):100∧goal(M):100

In the above-described case, “stepB(M)→stepY(M)→stepA(M)→stepC(M)→goal(M)”, “stepA(M)→stepX(M)→stepB(M)→stepC(M)→goal(M)”, etc., are generated as hypothesis candidates. Furthermore, since the smaller the weights, the lower the cost, “stepB(M)→stepY(M)→stepA(M)→stepC(M)→goal(M)” among the hypothesis candidates shown above is selected as a good hypothesis.

### LIST OF RELATED ART DOCUMENTS

### Non-Patent Document

Non-Patent Document 1: J. R. Hobbs, M. Stickel, P. Martin, and D. Edwards, “Interpretation as abduction”, Artificial Intelligence, Vol. 63, pp. 69-142, 1993.

### SUMMARY OF INVENTION

### Problems to be Solved by the Invention

Here, suppose that stepA(M) actually occurred earlier in time than stepB(M) although not being described in the above-described observations. Accordingly, if this is taken into consideration, “stepB(M)→stepY(M)→stepA(M)→stepC(M)→goal(M)” is incorrect, and “stepA(M)→stepX(M)→stepB(M)→stepC(M)→goal(M)” should be selected among the hypothesis candidates shown above.

However, in conventional weighted abductive inference, there is no mechanism for reflecting the temporal order relationship between observations in hypothesis candidates, and thus it is extremely difficult to eliminate such erroneous selections.

An example object of the invention is to provide an inference apparatus, an inference method, and a computer readable recording medium that can overcome the above-described problem and reflect the temporal order relationship between observations in hypothesis candidates.

### Means for Solving the Problems

In order to achieve the above-described object, an inference apparatus according to an example aspect of the invention includes:

a hypothesis candidate generation unit configured to perform inference by applying inference knowledge that includes information indicating a temporal sequence to observation in which facts that have been observed are expressed using logical expressions, and thereby generate a hypothesis candidate from which the observation can be derived; and

a contradiction examination unit configured to determine, on the basis of the information indicating a temporal sequence, whether or not the generated hypothesis candidate includes a temporal contradiction.

Also, in order to achieve the above-described object, an inference method according to an example aspect of the invention includes:
(a) a step of performing inference by applying inference knowledge that includes information indicating a temporal sequence to observation in which facts that have been observed are expressed using logical expressions, and thereby generating a hypothesis candidate from which the observation can be derived; and
(b) a step of determining, on the basis of the information indicating a temporal sequence, whether or not the generated hypothesis candidate includes a temporal contradiction.

Furthermore, in order to achieve the above-described object, a computer readable recording medium according to an example aspect of the invention includes recorded thereon a program including instructions that cause a computer to carry out:

(a) a step of performing inference by applying inference knowledge that includes information indicating a temporal sequence to observation in which facts that have been observed are expressed using logical expressions, and thereby generating a hypothesis candidate from which the observation can be derived; and

(b) a step of determining, on the basis of the information indicating a temporal sequence, whether or not the generated hypothesis candidate includes a temporal contradiction.

### Advantageous Effects of the Invention

As described above, according to the invention, the temporal order relationship between observations can be reflected in hypothesis candidates.

### BRIEF DESCRIPTION OF THE DRAWINGS

FIG. 1 is a block diagram illustrating the overall configuration of an inference apparatus in an example embodiment.

FIG. 2 is a block diagram illustrating the configuration of the inference apparatus in the example embodiment in detail.

FIG. 3 is a diagram illustrating one example of hypothesis candidate generation processing in the example embodiment.

FIG. 4 is a flowchart illustrating operations of the inference apparatus in the example embodiment.

FIG. 5 is a diagram illustrating specific examples of hypothesis candidates generated in the example embodiment.

FIG. 6 is a diagram illustrating one example of a hypothesis candidate displayed on a screen in the example embodiment.

FIG. 7 is a block diagram illustrating one example of a computer for realizing the inference apparatus in the example embodiment.

### EXAMPLE EMBODIMENT

### Example Embodiment

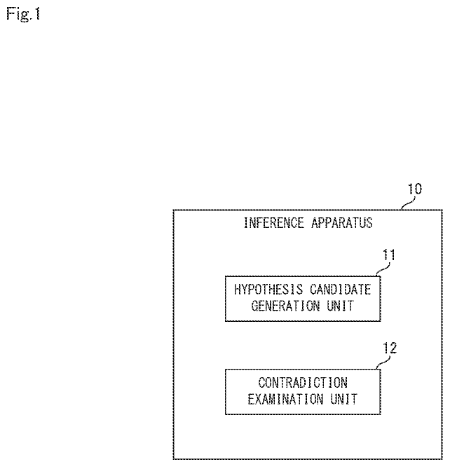

In the following, an inference apparatus, an inference method, and a program in the example embodiment will be described with reference to FIGS. 1 to 7.

[Apparatus Configuration]

First, the overall configuration of the inference apparatus in the example embodiment will be described with reference to FIG. 1. FIG. 1 is a block diagram illustrating the overall configuration of the inference apparatus in the example embodiment.

An inference apparatus 10 in the example embodiment, which is illustrated in FIG. 1, is an apparatus for deriving a hypothesis by applying inference knowledge to events that have been observed. As illustrated in FIG. 1, the inference apparatus 10 includes a hypothesis candidate generation unit 11 and a contradiction examination unit 12.

The hypothesis candidate generation unit 11 performs inference by applying inference knowledge that includes information indicating a temporal sequence (hereinafter “temporal sequence information”) to observation in which facts that have been observed are expressed using logical expressions, and thereby generates a hypothesis candidate from which the observation can be derived. The observation is a conjunction of literals of first-ordered logic. The contradiction examination unit 12 determines, on the basis of the temporal sequence information, whether or not the generated hypothesis candidate includes a temporal contradiction.

Since inference knowledge including temporal sequence information is used to determine whether or not a hypothesis candidate includes a temporal contradiction in such a manner, the temporal order relationship between observations can be reflected in hypothesis candidates according to the inference apparatus 10.

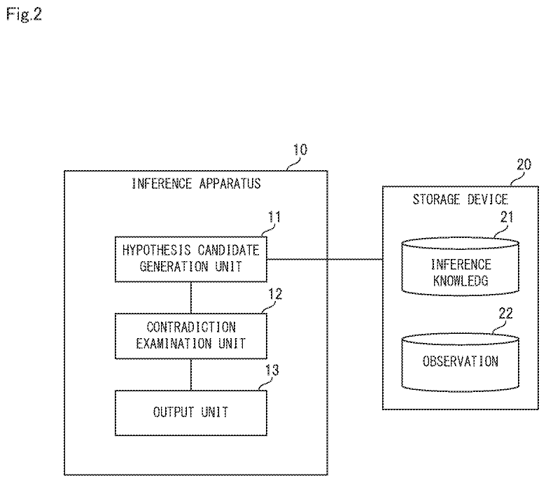

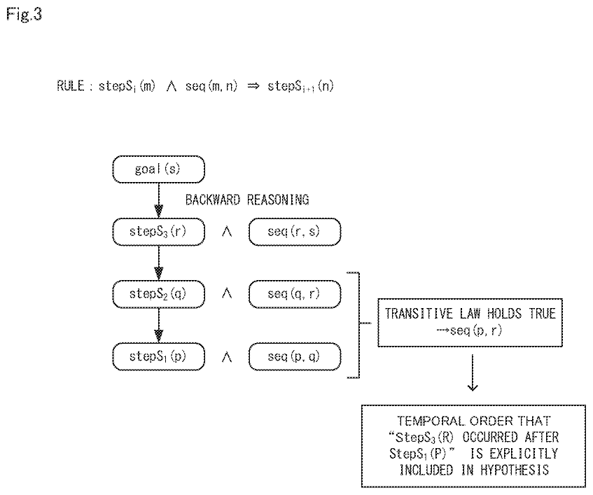

Next, the configuration of the inference apparatus in the example embodiment will be described in detail with reference to FIGS. 2 and 3. FIG. 2 is a block diagram illustrating the configuration of the inference apparatus in the example embodiment in detail.

In the example embodiment, the inference apparatus 10 includes an output unit 13 in addition to the hypothesis candidate generation unit 11 and the contradiction examination unit 12, as illustrated in FIG. 2. The output unit 13 outputs the result of the determination by the contradiction examination unit 12. Furthermore, in the example embodiment, the inference apparatus 10 is connected to a storage device 20, as illustrated in FIG. 2.

The storage device 20 stores therein inference knowledge 21 and observation 22. Furthermore, while the storage device 20 is external to the inference apparatus 10 and is connected to the inference apparatus 10 via a network or the like in the example in FIG. 2, there is no limitation to this example. The storage device 20 may be formed as a part of the inference apparatus 10. Furthermore, the inference knowledge 21 and the observation 22 may be stored in separate storage devices.

The inference knowledge 21 includes a plurality of rules, as is the case with conventional inference knowledge. However, in the example embodiment, at least one rule includes a predicate indicating a state in which a specific event has occurred as an antecedent, a predicate indicating a state in which an event subsequent to the specific event has occurred as a consequent, and also a predicate indicating a temporal order relationship as information indicating a temporal sequence.

Furthermore, in the example embodiment, seq(m, n), for example, is defined as a predicate indicating a temporal order relationship. seq(m, n) indicates a temporal order relationship in which “m is followed by n”. Furthermore, the three constraints below are imposed on seq(m, n) so that the temporal order relationship is satisfied.

Transitive law: seq(a, b)∧seq(b, c)⇒seq(a, c)

Asymmetric law: seq(a, b)⇒¬seq(b, a)

Irreflexive law: seq(a, a)⇒⊥

Accordingly, if the rules “stepSᵢ(m)∧seq(m, n)⇒stepSᵢ₊₁(n)” (where i is a natural number no smaller than 1 and no greater than 3) and “stepS₃(m)⇒goal(n)” are present and goal(s) is provided as an observation, the hypothesis candidate generation unit 11 generates the hypothesis candidate illustrated in FIG. 3, for example. Here, “stepSᵢ” is a predicate indicating a state in which a specific event has occurred, and “goal” is a query predicate. FIG. 3 is a diagram illustrating one example of hypothesis candidate generation processing in the example embodiment.

In the example embodiment, the contradiction examination unit 12 determines, on the basis of the predicate indicating the temporal order relationship, whether or not the hypothesis candidate generated by the hypothesis candidate generation unit 11 includes a temporal contradiction. Specifically, the contradiction examination unit 12 determines whether or not the hypothesis candidate includes a portion contradicting the temporal order relationship. Furthermore, if the contradiction examination unit 12 determines that the hypothesis candidate generated by the hypothesis candidate generation unit 11 includes a temporal contradiction, the contradiction examination unit 12 eliminates this hypothesis candidate.

In the example embodiment, the output unit 13 outputs only hypothesis candidates that were not eliminated to a display device, for example, and causes the display device to display on a screen thereof the hypothesis candidates that were not eliminated. Furthermore, the output unit 13 can also output the hypothesis candidates that were not eliminated to an external terminal device, an external database, or the like.

[Apparatus Operation]

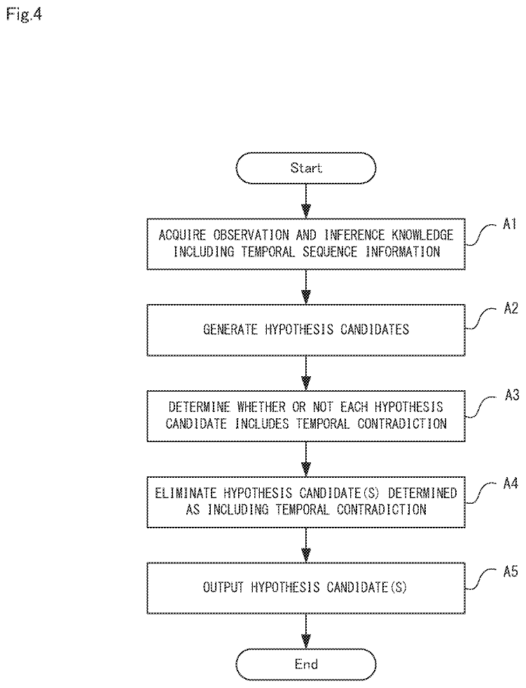

Next, operations of the inference apparatus 10 in the example embodiment will be described with reference to FIG. 4. FIG. 4 is a flowchart illustrating operations of the inference apparatus in the example embodiment. FIGS. 1 to 3 will be referred to as needed in the following description. Also, in the example embodiment, an inference method is implemented by causing the inference apparatus 10 to operate. Accordingly, the following description of the operations of the inference apparatus 10 is substituted for the description of the inference method in the example embodiment.

First, the hypothesis candidate generation unit 11 acquires, from the storage device 20, observation 22 and inference knowledge 21 including temporal sequence information, as illustrated in FIG. 4 (step A1). Next, the hypothesis candidate generation unit 11 generates hypothesis candidates by applying the inference knowledge 21 to the observation 22 acquired in step A1 (step A2).

Next, the contradiction examination unit 12 determines, on the basis of the temporal sequence information, whether or not each of the hypothesis candidates generated in step A2 includes a temporal contradiction (step A3). Next, the contradiction examination unit 12 specifies one or more hypothesis candidates that have been determined as including a temporal contradiction in step A3, and eliminates the specified hypothesis candidates (step A4).

Subsequently, the output unit 13 outputs one or more hypothesis candidates that were not eliminated in step A4 to an external display device, terminal device, database, or the like (step A5).

### Specific Example

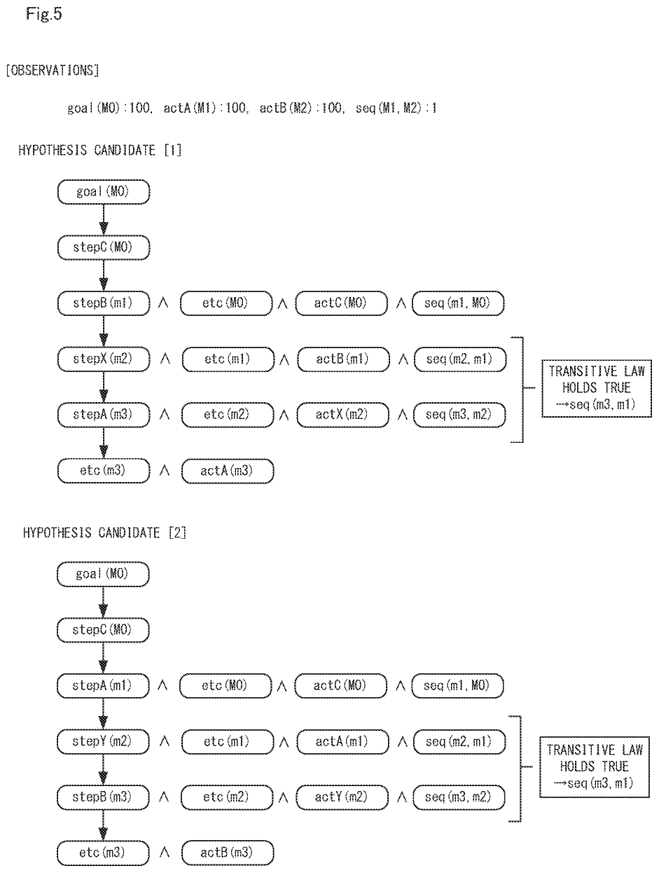

Next, a specific example of the processing illustrated in FIG. 4 will be described with reference to FIG. 5. FIG. 5 is a diagram illustrating specific examples of hypothesis candidates generated in the example embodiment.

First, the hypothesis candidate generation unit 11 acquires “goal(M0):100, actA(M1):100, actB(M2):100, seq(M1, M2):1” as observation 22 from the storage device. Furthermore, the value appended to each logical formula is a cost. The hypothesis candidate generation unit 11 acquires the set of the rules shown below as inference knowledge 21 from the storage device.

etc(n):0.2∧actA(n):0.0⇒stepA(n)

etc(n):0.2∧actB(n):0.0⇒stepB(n)

stepA(m):1.0∧etc(n):0.4∧actX(n):0.0∧seq(m, n):0.0⇒stepX(n)

stepB(m):1.0∧etc(n):0.3∧actY(n):0.0∧seq(m, n):0.0⇒stepY(n)

stepX(m):1.0∧etc(n):0.4∧actB(n):0.0∧seq(m, n):0.0⇒stepB(n)

stepY(m):1.0∧etc(n):0.3∧actA(n):0.0∧seq(m, n):0.0⇒stepA(n)

stepB(m):1.0∧etc(n):0.4∧actC(n):0.0∧seq(m, n):0.0⇒stepC(n)

stepA(m):1.0∧etc(n):0.3∧actC(n):0.0∧seq(m, n):0.0⇒stepC(n)

stepC(m):1.0 goal(m)

Note that the numerical value appended to each literal in the rules shown above is a weight. Each of “step A”, “step B”, etc., is a predicate indicating a state of being in step A or step B. Here, the steps are constituent elements of a cyber kill chain (lateral movement, exfiltration, etc.) or the like, for example. The predicate “etc” is for adding the unlikeliness of the occurrence of the corresponding rule (functions as a weight in weighted abductive inference). Each of the predicates “actB”, “actC”, etc., indicates a trace relating to step B or step C. The arguments m and n in each predicate are identifiers (IDs) whose order can be uniquely identified, such as time. The predicate “goal” is a query predicate.

Next, the hypothesis candidate generation unit 11 executes inference by applying the rules shown above to the acquired observation 22. Thus, the hypothesis candidate generation unit 11 generates hypothesis candidate [1] (stepA(m3)→stepX(m2)→stepB(m1)→stepC(M0)→goal(M0)) and hypothesis candidate [2] (stepB(m3)→stepY(m2)→stepA(m1)→stepC(M0)→goal(M0)) shown in FIG. 5, etc. Here, “→” indicates the transition between steps.

While it is preferable for only hypothesis candidate [1] to be generated because B has occurred after A according to seq(M1, M2) in the observation shown above, hypothesis candidate [2] is also generated. Thus, the contradiction examination unit 12 eliminates hypothesis candidate [2], which contradicts seq(M1, M2).

Specifically, in hypothesis candidate [1], seq(m3, m1) can be obtained by applying the transitive law to seq(m2, m1) and seq(m3, m2). m3=M1 and m1=M2 can be obtained by unifying actA(m3) and actB(m1) in hypothesis candidate [1] with the observations actA(M1) and actB(M2), respectively. In this case, seq(m3, m1) equals seq(M1, M2), and does not contradict the observation seq(M1, M2). Accordingly, the contradiction examination unit 12 determines that hypothesis candidate [1] is not contradictory. On the other hand, in hypothesis candidate [2], seq(m3, m1) can be obtained by applying the transitive law to seq(m2, m1) and seq(m3, m2). m1=M1 and m3=M2 can be obtained by unifying actA(m1) and actB(m3) in hypothesis candidate [1] with the observations actA(M1) and actB(M2), respectively. In this case, seq(m3, m1) equals seq(M2, MD, and contradicts the observation seq(M1, M2). Accordingly, the contradiction examination unit 12 determines that hypothesis candidate [2] is contradictory. Thus, the contradiction examination unit 12 eliminates hypothesis candidate [2], which contradicts seq(M1, M2), as described above. Note that unification is an operation in which a hypothesis is set up that the arguments in two literals with the same predicate are equivalent.

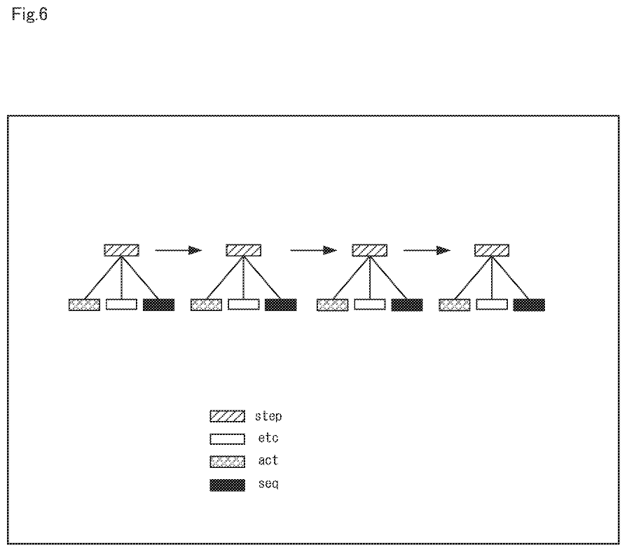

Furthermore, the output unit 13 displays the hypothesis candidates that were not eliminated on a screen of a display device for example, as illustrated in FIG. 6. FIG. 6 is a diagram illustrating one example of a hypothesis candidate displayed on the screen in the example embodiment. In the example in FIG. 6, the hypothesis candidate is displayed by means of a graph indicating the relationships between step, etc, act, and seq. The user can acknowledge the order in which events occurred by following the step nodes, and can acknowledge the details of acts by checking the act nodes.

[Effects of Embodiment]

As described above, in the example embodiment, hypothesis candidates that include temporal contradictions can be eliminated after the hypothesis candidates are generated because inference is performed using inference knowledge including temporal sequence information. Thus, the inference apparatus 10 in the present example embodiment can reflect the temporal order relationship between observations in hypothesis candidates.

[Modification]

Here, a modification in the example embodiment will be described. In the present modification, the contradiction examination unit 12 appends, to each hypothesis candidate generated by the hypothesis candidate generation unit 11, an index indicating the possibility of the hypothesis candidate not holding true. Furthermore, the contradiction examination unit 12, if determining that the hypothesis candidate includes a temporal contradiction, corrects the value of the index of the hypothesis candidate.

For example, in the specific example described above, suppose that “goal(M0):100, actA(M1):100, actB(M2):100, seq(M1, M2):1, actY(M3):100” have been acquired as observation 22. This case differs from the specific example described above in that “actY(M3):100” is added. Furthermore, in this case as well, the hypothesis candidate generation unit 11 generates hypothesis candidate [1] (stepA(m3)→stepX(m2)→stepB(m1)→stepC(M0)→goal(M0)) and hypothesis candidate [2] (stepB(m3)→stepY(m2)→stepA(m1)→stepC(M0)→goal(M0)) shown in FIG. 5, etc., as hypothesis candidates.

In the above-described example, if unification with the observations actA(M1) and actB(M2) is performed in hypothesis candidate [1], there is no contradiction with seq(M1, M2). However, the observation actY(M3) cannot be unified, and the cost remains the same. On the other hand, if unification with the observations actA(M1) and actB(M2) is performed in hypothesis candidate [2], there is a contradiction with seq(M1, M2). However, actY(M3) can be unified, and the cost can be reduced accordingly.

Thus, in the present modification, for each hypothesis candidate, the contradiction examination unit 12 uses the cost calculated upon generation of the hypothesis candidate as an index indicating the possibility of the hypothesis candidate not holding true, and appends the cost (index) to the hypothesis candidate. Furthermore, the contradiction examination unit 12, if determining that the hypothesis candidate includes a temporal contradiction, sets a penalty for the hypothesis candidate and adds the penalty so set as an additional cost to the cost calculated beforehand. Subsequently, the output unit 13 outputs each hypothesis candidate to the outside in a state in which the hypothesis candidate has a cost appended thereto.

Note that the initial cost is calculated by the hypothesis candidate generation unit 11 from the weights added to the rules and the costs appended to the observation. Furthermore, a preset value is used as the penalty, for example.

As described above, in the modification, whether a hypothesis conforming to the observation (seq(M1, M2)) will be adopted or a hypothesis contradicting the observation (seq(M1, M2)) will be adopted is determined by the trade-off between an increase in cost as a penalty for the contradiction and a decrease in cost by hypothesis unification, etc.

[Program]

It suffices for a program in the example embodiment to be a program that causes a computer to carry out steps A1 to A5 illustrated in FIG. 4. By installing this program on a computer and executing the program, the inference apparatus 10 and the inference method in the example embodiment can be realized. In this case, the processor of the computer functions and performs processing as the hypothesis candidate generation unit 11, the contradiction examination unit 12, and the output unit 13.

Furthermore, the program in the example embodiment may be executed by a computer system formed from a plurality of computers. In this case, the computers may each function as one of the hypothesis candidate generation unit 11, the contradiction examination unit 12, and the output unit 13 for example.

Furthermore, the storage device 20 may be a storage device such as a hard disk provided in the computer that executes the program in the example embodiment, or may be a storage device provided on another different computer.

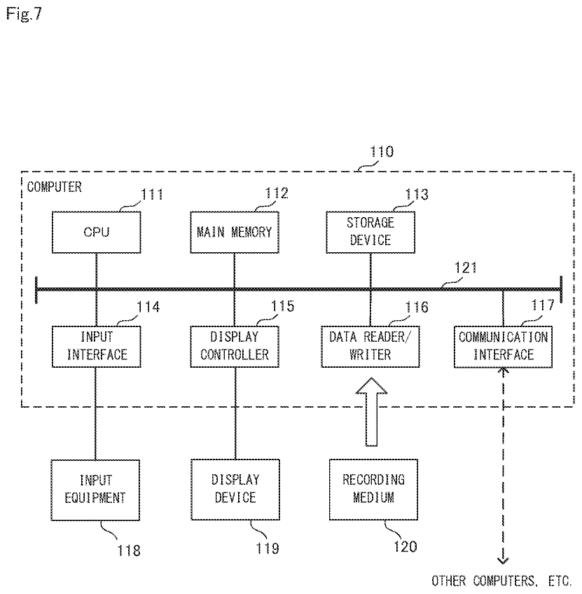

Here, a computer that realizes the inference apparatus 10 by executing the program in the example embodiment will be described with reference to FIG. 7. FIG. 7 is a block diagram illustrating one example of a computer for realizing the inference apparatus in the example embodiment.

As illustrated in FIG. 7, a computer 110 includes a central processing unit (CPU) 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the program (codes) in the present example embodiment, which is stored in the storage device 113, onto the main memory 112, and performs various computations by executing these codes in a predetermined order. The main memory 112 is typically a volatile storage device such as a dynamic random access memory (DRAM). Furthermore, the program in the present example embodiment is provided in a state such that the program is stored in a computer readable recording medium 120. Note that the program in the present example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading out of the program from the recording medium 120 and the writing of results of processing in the computer 110 to the recording medium 120. The communication interface 117 mediates data transmission between the CPU 111 and other computers.

Furthermore, specific examples of the recording medium 120 include a general-purpose semiconductor storage device such as a CompactFlash (registered trademark, CF) card or a Secure

Digital (SD) card, a magnetic recording medium such as a flexible disk, and an optical recording medium such as a compact disk read-only memory (CD-ROM).

Note that the inference apparatus 10 in the present example embodiment can also be realized by using pieces of hardware corresponding to the respective units, rather than using a computer on which the program is installed. Furthermore, a part of the inference apparatus 10 may be realized by using the program, and the remaining part of the inference apparatus 10 may be realized by using hardware.

While a part of or the entirety of the above-described example embodiment can be expressed by (Supplementary note 1) to (Supplementary note 12) described in the following, the invention is not limited to the following description.

(Supplementary Note 1)

An inference apparatus including:

a hypothesis candidate generation unit configured to perform inference by applying inference knowledge that includes information indicating a temporal sequence to observation in which facts that have been observed are expressed using logical expressions, and thereby generate a hypothesis candidate from which the observation can be derived; and

a contradiction examination unit configured to determine, on the basis of the information indicating a temporal sequence, whether or not the generated hypothesis candidate includes a temporal contradiction.

(Supplementary Note 2)

The inference apparatus according to Supplementary note 1, wherein

the inference knowledge includes a plurality of rules, and

at least one of the plurality of rules includes:

a predicate indicating a temporal order relationship as the information indicating a temporal sequence;

a predicate indicating a state in which a specific event has occurred as an antecedent; and

a predicate indicating a state in which an event subsequent to the specific event has occurred as a consequent.

(Supplementary Note 3)

The inference apparatus according to Supplementary note 1 or 2, wherein

the contradiction examination unit,

if determining that the generated hypothesis candidate includes a temporal contradiction, eliminates the hypothesis candidate.

(Supplementary Note 4)

The inference apparatus according to Supplementary note 1 or 2, wherein

the contradiction examination unit appends, to the generated hypothesis candidate, an index indicating the possibility of the hypothesis candidate not holding true, and the contradiction examination unit, if determining that the hypothesis candidate includes a temporal contradiction, further corrects the value of the index of the hypothesis candidate.

(Supplementary Note 5)

An inference method including:

(a) a step of performing inference by applying inference knowledge that includes information indicating a temporal sequence to observation in which facts that have been observed are expressed using logical expressions, and thereby generating a hypothesis candidate from which the observation can be derived; and

(b) a step of determining, on the basis of the information indicating a temporal sequence, whether or not the generated hypothesis candidate includes a temporal contradiction.

(Supplementary Note 6)

The inference method according to Supplementary note 5, wherein

the inference knowledge includes a plurality of rules, and

at least one of the plurality of rules includes:
a predicate indicating a temporal order relationship as the information indicating a temporal sequence;
a predicate indicating a state in which a specific event has occurred as an antecedent; and
a predicate indicating a state in which an event subsequent to the specific event has occurred as a consequent.

(Supplementary Note 7)

The inference method according to Supplementary note 5 or 6, further including

(c) a step of eliminating the hypothesis candidate generated in the (a) step if it is determined in the (b) step that the hypothesis candidate includes a temporal contradiction.

(Supplementary Note 8)

The inference method according to Supplementary note 5 or 6, further including

(d) a step of appending, to the hypothesis candidate generated in the (a) step, an index indicating the possibility of the hypothesis candidate not holding true, and further of, if it is determined in the (b) step that the hypothesis candidate includes a temporal contradiction, correcting the value of the index of the hypothesis candidate.

(Supplementary Note 9)

A computer readable recording medium that includes a program recorded thereon, the program including instructions that cause a computer to carry out:

(a) a step of performing inference by applying inference knowledge that includes information indicating a temporal sequence to observation in which facts that have been observed are expressed using logical expressions, and thereby generating a hypothesis candidate from which the observation can be derived; and

(b) a step of determining, on the basis of the information indicating a temporal sequence, whether or not the generated hypothesis candidate includes a temporal contradiction.

(Supplementary Note 10)

The computer readable recording medium according to Supplementary note 9, wherein

the inference knowledge includes a plurality of rules, and

at least one of the plurality of rules includes:
a predicate indicating a temporal order relationship as the information indicating a temporal sequence;
a predicate indicating a state in which a specific event has occurred as an antecedent; and
a predicate indicating a state in which an event subsequent to the specific event has occurred as a consequent.

(Supplementary Note 11)

The computer readable recording medium according to Supplementary note 9 or 10, wherein

the program further includes instructions that cause the computer to carry out

(c) a step of eliminating the hypothesis candidate generated in the (a) step if it is determined in the (b) step that the hypothesis candidate includes a temporal contradiction.

(Supplementary Note 12) The computer readable recording medium according to Supplementary note 9 or 10, wherein

the program further includes instructions that cause the computer to carry out

(d) a step of appending, to the hypothesis candidate generated in the (a) step, an index indicating the possibility of the hypothesis candidate not holding true, and further of, if it is determined in the (b) step that the hypothesis candidate includes a temporal contradiction, correcting the value of the index of the hypothesis candidate.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the invention, the temporal order relationship between observations can be reflected in hypothesis candidates. The invention is useful in fields in which abductive inference is necessary, such as the field of server security.

### REFERENCE SIGNS LIST

10 Inference apparatus
11 Hypothesis candidate generation unit
12 Contradiction examination unit
13 Output unit
20 Storage device
21 Inference knowledge
22 Observation inference
110 Computer
111 CPU
112 Main memory
113 Storage device
114 Input interface
115 Display controller
116 Data reader/writer
117 Communication interface
118 Input equipment
119 Display device
120 Storage medium
121 Bus

What is claimed is:

1. An inference apparatus comprising:
at least one memory storing instructions; and
at least one processor configured to execute the instructions to:
perform inference by applying inference knowledge that includes information indicating a temporal sequence to observation in which facts that have been observed are expressed using logical expressions, and thereby generate a hypothesis candidate from which the observation can be derived; and
a contradiction examination means for determining, on the basis of the information indicating a temporal sequence, whether or not the generated hypothesis candidate includes a temporal contradiction.

2. The inference apparatus according to claim 1, wherein
the inference knowledge includes a plurality of rules, and
at least one of the plurality of rules includes:
a predicate indicating a temporal order relationship as the information indicating a temporal sequence;
a predicate indicating a state in which a specific event has occurred as an antecedent; and
a predicate indicating a state in which an event subsequent to the specific event has occurred as a consequent.

3. The inference apparatus according to claim 1, wherein
further at least one processor configured to execute the instructions to:
if determining that the generated hypothesis candidate includes a temporal contradiction, eliminate the hypothesis candidate.

4. The inference apparatus according to claim 1, wherein
further at least one processor configured to execute the instructions to:
append, to the generated hypothesis candidate, an index indicating the possibility of the hypothesis candidate not holding true, and the contradiction examination means, if determining that the hypothesis candidate includes a temporal contradiction, further correct the value of the index of the hypothesis candidate.

5. An inference method comprising:
performing inference by applying inference knowledge that includes information indicating a temporal sequence to observation in which facts that have been observed are expressed using logical expressions, and thereby generating a hypothesis candidate from which the observation can be derived; and
determining, on the basis of the information indicating a temporal sequence, whether or not the generated hypothesis candidate includes a temporal contradiction.

6. The inference method according to claim 5, wherein
the inference knowledge includes a plurality of rules, and
at least one of the plurality of rules includes:
a predicate indicating a temporal order relationship as the information indicating a temporal sequence;
a predicate indicating a state in which a specific event has occurred as an antecedent; and
a predicate indicating a state in which an event subsequent to the specific event has occurred as a consequent.

7. The inference method according to claim 5, further comprising
eliminating the hypothesis candidate generated in the generating if it is determined in the determining that the hypothesis candidate includes a temporal contradiction.

8. The inference method according to claim 5, further comprising
appending, to the hypothesis candidate generated in the generating, an index indicating the possibility of the hypothesis candidate not holding true, and further of, if it is determined in the determining that the hypothesis candidate includes a temporal contradiction, correcting the value of the index of the hypothesis candidate.

9. A non-transitory computer readable recording medium that includes a program recorded thereon, the program including instructions that cause a computer to carry out:
a step of performing inference by applying inference knowledge that includes information indicating a temporal sequence to observation in which facts that have been observed are expressed using logical expressions, and thereby generating a hypothesis candidate from which the observation can be derived; and
a step of determining, on the basis of the information indicating a temporal sequence, whether or not the generated hypothesis candidate includes a temporal contradiction.

10. The non-transitory computer readable recording medium according to claim 9, wherein
the inference knowledge includes a plurality of rules, and
at least one of the plurality of rules includes:
a predicate indicating a temporal order relationship as the information indicating a temporal sequence;
a predicate indicating a state in which a specific event has occurred as an antecedent; and
a predicate indicating a state in which an event subsequent to the specific event has occurred as a consequent.

11. The non-transitory computer readable recording medium according to claim 9, wherein
the program further includes instructions that cause the computer to carry out
a step of eliminating the hypothesis candidate generated in the generating step if it is determined in the determining step that the hypothesis candidate includes a temporal contradiction.

12. The non-transitory computer readable recording medium according to claim 9, wherein
the program further includes instructions that cause the computer to carry out
a step of appending, to the hypothesis candidate generated in the generating step, an index indicating the possibility of the hypothesis candidate not holding true, and further of, if it is determined in the determining step that the hypothesis candidate includes a temporal contradiction, correcting the value of the index of the hypothesis candidate.
